(19) United States
(12) Patent Application Publication
(10) Pub. No.: US 2014/0013276 A1
(43) Pub. Date: Jan. 9, 2014

(54) Accessing a Marine Electronics Data Menu

(71) Applicant: NAVICO HOLDING AS, Egersund (NO)

(72) Inventor: Paul Butterworth, Auckland (NZ)

(21) Appl. No.: 13/804,850

(22) Filed: Mar. 14, 2013

Related U.S. Application Data
(60) Provisional application No. 61/708,544, filed on Oct. 1, 2012.
(60) Provisional application No. 61/668,962, filed on Jul. 6, 2012.

(51) Int. Cl. G06F 3/0488; G06F 3/0482

(52) U.S. Cl. CPC G06F 3/04886; G06F 3/0482
USPC 715/821

(57) ABSTRACT

Accessing a marine electronics data menu. A non-transitory computer-readable medium may store a plurality of computer-executable instructions which, when executed by a computer, cause the computer to display marine electronics data on a touch screen on a multi function display unit, receive a display request to display a marine electronics data menu that is generally hidden from the touch screen, and display the marine electronics data menu on the touch screen in response to the display request by moving the marine electronics data menu across the touch screen in a first direction.

### CROSS-REFERENCE TO RELATED APPLICATIONS

This application claims benefit of U.S. provisional patent application Ser. No. 61/668,962, filed Jul. 6, 2012 and titled HIDDEN SYSTEM MENU, and U.S. provisional patent application Ser. No. 61/708,544, filed Oct. 1, 2012 and titled HIDDEN SYSTEM MENU, the entire disclosures of which are herein incorporated by reference.

### BACKGROUND

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Marine electronics data, such as, for example, sonar data, chart data, radar data, or navigation data, may be processed and/or displayed using any number of sonar modules. One such sonar module may include a multi-function display (MFD). A user may access the marine electronics data through various menus, submenus, or menu options of the MFD.

### SUMMARY

Described herein are implementations of various technologies for accessing a marine electronics data menu. In one implementation, a non-transitory computer-readable medium may store a plurality of computer-executable instructions which, when executed by a computer, cause the computer to display marine electronics data on a touch screen on a multi function display unit, receive a display request to display a marine electronics data menu that is generally hidden from the touch screen, and display the marine electronics data menu on the touch screen in response to the display request by moving the marine electronics data menu across the touch screen in a first direction.

In another implementation, a non-transitory computer-readable medium may store a plurality of computer-executable instructions which, when executed by a computer, cause the computer to display a scroll indicator on a menu of a touch screen on a multi function display unit, where the scroll indicator indicates additional menu options generally hidden from the touch screen. The plurality of computer-executable instructions are further configured to cause the computer to receive a command to scroll the menu and display the additional menu options in response to receiving the command to scroll.

In yet another implementation, a non-transitory computer-readable medium may store a plurality of computer-executable instructions which, when executed by a computer, cause the computer to display a marine electronics tray menu having one or more options displayed on a touch screen of a multi-function display and one or more options hidden from the touch screen and receive a request to more fully display the one or more hidden options. The request may be received at the marine electronics tray menu. The plurality of computer-executable instructions are further configured to cause the computer to display the one or more hidden options more fully on the touch screen in response to the receiving the request.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 is a schematic diagram of a multi-function display (MFD) in accordance with various techniques described therein.

FIG. 2 illustrates a schematic diagram of a touch screen of the MFD in accordance with implementations of various techniques described herein.

FIG. 3 illustrates a schematic diagram of a partially displayed hidden system menu in response to a user's gross swipe gesture at a tab marker in accordance with implementations of various techniques described herein.

FIG. 4 illustrates a schematic diagram of a fully displayed hidden system menu in accordance with implementations of various techniques described herein.

FIG. 5 illustrates a schematic diagram of a touch screen in accordance with implementations of various techniques described herein.

FIG. 6 illustrates a schematic diagram of a touch screen of the MFD in accordance with implementations of various techniques described herein.

FIG. 7 illustrates a schematic diagram of a touch screen of the MFD in accordance with implementations of various techniques described herein.

FIG. 8 illustrates a schematic diagram of a touch screen of the MFD in accordance with implementations of various techniques described herein.

FIG. 9 illustrates a schematic diagram of a touch screen of the MFD in accordance with implementations of various techniques described herein.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

The following paragraphs provide a brief summary of various technologies and techniques directed at accessing a marine electronics data menu.

The multi-function display (MFD) may be used to display and/or process marine electronics data, such as chart data, sonar data, structure data, radar data, navigation data, or any other type known to those skilled in the art. In operating the MFD, a user may select one or more types of marine electronics data to be displayed on the MFD. The user may enhance, alter, and/or edit the displayed marine electronics data through various parameters or settings available on the MFD.

In one implementation, the touch screen may also display a tab marker of a hidden system menu, where the hidden system menu may provide further options to enhance, alter, and/or edit the displayed marine electronics data. The hidden system menu may, initially, be generally hidden from the user's perspective on the touch screen. However, the tab marker may represent a portion of the hidden system menu that is displayed to the user.

The portion of the hidden system menu that is generally hidden from the user's perspective may be displayed when the user sends a display request to the touch screen. In particular, the user may send the display request by touching an area of the touch screen at or proximate to the tab marker. In one implementation, in order to send the display request, the user may perform a first gross swipe gesture at the tab marker, and the hidden system menu may be generally displayed by moving across the touch screen 105 in the same direction as the first gross swipe gesture.

As mentioned above, the hidden system menu may include one or more hidden system options to enhance, alter, and/or edit the displayed marine electronics data. For example, the hidden system options may include an option to add or remove data overlays on the displayed marine electronics data, an option to add or remove an audio bar, or an option to access further settings relating to the displayed marine electronics data. Each of the hidden system options may be selected by the user via touching of the touch screen.

The user may also send a hide request to the touch screen in the area at or proximate to the tab marker in order to generally hide the hidden system menu after it has been displayed. In one implementation, in order to send the hide request, the user may perform a second gross swipe gesture at the tab marker in a direction opposite to the first swipe gesture. The hidden system menu may then be generally hidden by moving across the touch screen in the same direction as the second gross swipe gesture.

In another implementation, the hidden system menu may be scrollable, such that a user may be able to touch and drag the contents of the menu in an up-and-down or left-to-right direction in order to scroll through all of the options of the menu. The user may scroll through the menu by touching and dragging the contents on the menu using any portion of the menu. Upon scrolling through the menu, generally hidden and/or partially-displayed options of the menu may become fully displayed and accessible to the user on the touch screen.

A scroll indicator on the menu may provide notice to the user of the existence of the menu's generally hidden options, where these options may become displayed and accessible upon scrolling through the menu. In one implementation, the scroll indicator may be a partially-displayed option of the menu itself. For example, the partially-displayed option may be at one end of the menu, such that only a top-half or bottom-half of the option is displayed on the touch screen.

The scroll indicator may be an arrow indicator. The arrow indicator indicates to the user that there are generally hidden options of the side menu that are not being displayed on the touch screen. The user may access the generally hidden options by scrolling through the menu, i.e., by touching and dragging the menu, in the opposite direction of the arrow.

In yet another implementation, the touch screen may display a home screen. The home screen may also display one or more tray menus, which may include one or more displayed tray options used to display, enhance, alter, and/or edit marine electronics data. The tray menus may be placed along any edge of the touch screen. The displayed tray options may be displayed when the tray menus to which they belong are in use, and the user may select any of the displayed tray options by touching the touch screen.

Each tray menu may also have one or more hidden tray options that, initially, may be generally hidden from the user's perspective on the touch screen. Similar to the displayed tray options, the hidden tray options may also be used to display, enhance, alter, and/or edit marine electronics data. In order to generally display the hidden tray options for a tray menu on the touch screen, the user may send a tray display request to the touch screen at or proximate to the tray menu.

In one implementation, in order to send the tray display request, the user may perform a first tray gross swipe gesture across the tray menu, and the tray menu may move across the touch screen in the same direction as the first tray gross swipe gesture. The hidden tray options may then be generally displayed once the tray menu has moved across the touch screen. The user may also send the tray display request by selecting one of the displayed tray options by touching the touch screen. For example, one of the displayed tray options may be an arrow option, where selection of the arrow option may cause the tray menu to move across the touch screen in the same direction as pointed to by the arrow option. The hidden tray options may then be generally displayed once the tray menu has moved across the touch screen.

The user may also send a tray hide request to the touch screen at or proximate to a tray menu in order to generally hide its hidden tray options. In one implementation, in order to send the hide request, the user may perform a second tray gross swipe gesture across the tray menu in a direction opposite to the first tray swipe gesture. The hidden tray options may then be generally hidden by moving the tray menu across the touch screen in the same direction as the second tray gross swipe gesture. In another implementation, the user may send the tray hide request by selecting one of the displayed tray options by touching the touch screen. For example, one of the displayed tray options may be an arrow option, where selection of the arrow option may cause the tray menu to move across the touch screen in the same direction as pointed to by the arrow option.

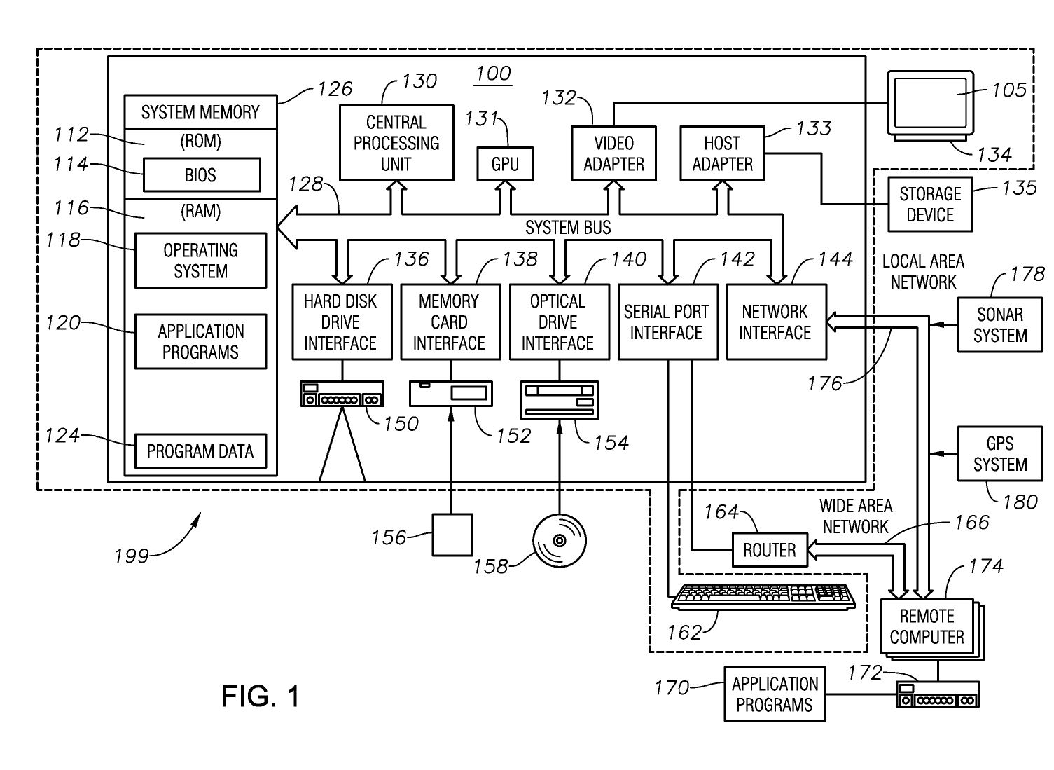

Various implementations of accessing a marine electronics data menu described above will now be described in more detail with reference to FIGS. 1-9.

### Multi-Function Display

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The various technologies described herein may be implemented in the general context of computer-executable instructions, such as program modules, being executed by a computer. Generally, program modules include routines, programs, objects, components, data structures, etc. that performs particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

FIG. 1 illustrates a schematic diagram of a multi-function display (MFD) 199 comprising a computing system 100 in which the various technologies described herein may be incorporated and practiced. The computing system 100 may be a conventional desktop, a handheld device, personal digital assistant, a server computer, electronic device/instrument, laptop, tablet, or part of a navigation system, marine electronics, or sonar system. It should be noted, however, that other computer system configurations may be used.

The computing system 100 may include a central processing unit (CPU) 130, a system memory 126, a graphics processing unit (GPU) 131 and a system bus 128 that couples various system components including the system memory 126 to the CPU 130. Although only one CPU 130 is illustrated in FIG. 1, it should be understood that in some implementations the computing system 100 may include more than one CPU 130.

The CPU 130 can include a microprocessor, a microcontroller, a processor, a programmable integrated circuit, or a combination thereof. The CPU 130 can comprise an off-the-shelf processor such as a Reduced Instruction Set Computer (RISCTM), or a Microprocessor without Interlocked Pipeline Stages (MIPSTM) processor, or a combination thereof. The CPU 130 may also include a proprietary processor.

The GPU 131 may be a microprocessor specifically designed to manipulate and implement computer graphics. The CPU 130 may offload work to the GPU 131. The GPU 131 may have its own graphics memory, and/or may have access to a portion of the system memory 126. As with the CPU 130, the GPU 131 may include one or more processing units, and each processing unit may include one or more cores.

The CPU 130 may provide output data to a GPU 131. The GPU 131 may generate graphical user interfaces that present the output data. The GPU 131 may also provide objects, such as menus, in the graphical user interface. A user may provide inputs by interacting with the objects. The GPU 131 may receive the inputs from interaction with the objects and provide the inputs to the CPU 130. A video adapter 132 may be provided to convert graphical data into signals for a monitor 134. The monitor 134 includes a screen 105. The screen 105 can be sensitive to heat or touching (now collectively referred to as a “touch screen”).

The system bus 128 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 126 may include a read only memory (ROM) 112 and a random access memory (RAM) 116. A basic input/output system (BIOS) 114, containing the basic routines that help transfer information between elements within the computing system 100, such as during start-up, may be stored in the ROM 112.

The computing system 100 may further include a hard disk drive interface 136 for reading from and writing to a hard disk 150, a memory card reader 152 for reading from and writing to a removable memory card 156, and an optical disk drive 154 for reading from and writing to a removable optical disk 158, such as a CD ROM or other optical media. The hard disk 150, the memory card reader 152, and the optical disk drive 154 may be connected to the system bus 128 by a hard disk drive interface 136, a memory card reader interface 138, and an optical drive interface 140, respectively. The drives and their associated computer-readable media may provide nonvolatile storage of computer-readable instructions, data structures, program modules and other data for the computing system 100.

Although the computing system 100 is described herein as having a hard disk, a removable memory card 156 and a removable optical disk 158, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The computing system 100 may also include a host adapter 133 that connects to a storage device 135 via a small computer system interface (SCSI) bus, a Fiber Channel bus, an eSATA bus, or using any other applicable computer bus interface. The computing system 100 can also be connected to a router 164 to establish a wide area network (WAN) 166 with one or more remote computers 174. The remote computers 174 can also include hard disks 172 that store application programs 170.

A number of program modules may be stored on the hard disk 150, memory card 156, optical disk 158, ROM 112 or RAM 116, including an operating system 118, one or more application programs 120, and program data 124. In certain implementations, the hard disk 150 may store a database system. The database system could include, for example, recorded points. The application programs 120 may include various mobile applications (“apps”) and other applications configured to perform various methods and techniques described herein. The operating system 118 may be any suitable operating system that may control the operation of a networked personal or server computer.

A user may enter commands and information into the computing system 100 through input devices such as buttons 162. Other input devices may include a microphone (not shown). These and other input devices may be connected to the CPU 130 through a serial port interface 142 coupled to system bus 128, but may be connected by other interfaces, such as a parallel port, game port or a universal serial bus (USB).

Certain implementations may be configured to be connected to a GPS system 180, and/or a sonar system 178. The GPS system 180, and/or sonar system 178 may be connected via the network interface 144. The computing system 100, the monitor 134, the screen 105, and the buttons 162 may be integrated into a console, now referred to as a multi-function display (MFD) 199. The sonar system 178 may include a transducer array and/or sonar module configured to transmit sonar data to the MFD 199 for processing and/or display.

### Operation

### Hidden System Menu

The MFD 199 may be used to display and/or process marine electronics data, such as chart data, sonar data, structure data, radar data, navigation data, or any other type known to those skilled in the art. In operating the MFD 199, a user may select one or more types of marine electronics data to be displayed on the MFD 199. The user may enhance, alter, and/or edit the displayed marine electronics data through various parameters or settings available on the MFD 199.

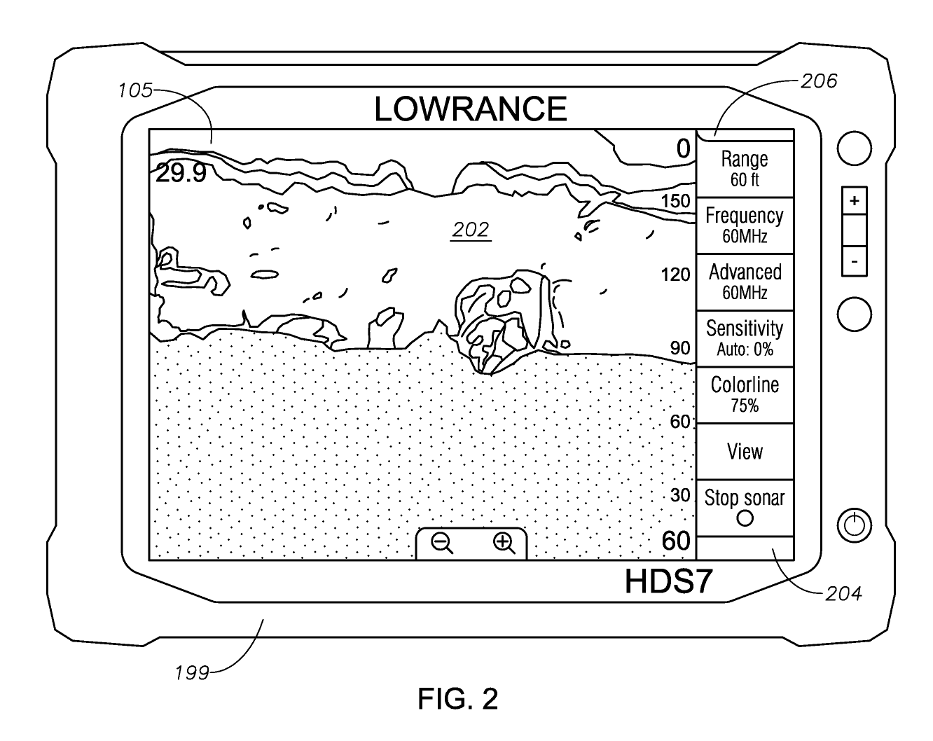

FIG. 2 illustrates a schematic diagram of touch screen 105 of the MFD 199 in accordance with implementations of various techniques described herein. In one implementation, the touch screen 105 may display sonar data 202, as shown in FIG. 2. In addition, the touch screen 105 may also display a side menu 204, which may include one or more side options to enhance, alter, and/or edit the displayed sonar data 202. The side menu 204 may be displayed at or proximate to an edge of the touch screen 105. The user may select any of the side options via touching of the touch screen 105. In one implementation, the side options may include options to alter a range, a frequency, a sensitivity, a colorline, or other settings of marine electronics data being displayed on the touch screen.

The touch screen 105 may also display a tab marker 206 of a hidden system menu, where the hidden system menu may provide further options to enhance, alter, and/or edit the displayed sonar data 202. The hidden system menu may, initially, be generally hidden from the touch screen 105. For example, the hidden system menu may be generally hidden from the user's perspective. However, the tab marker 206 may represent a portion of the hidden system menu that is displayed to the user. The hidden system menu and, in turn, the tab marker 206 may be placed at any suitable portion of the touch screen 105, including an area proximate to any edge of the touch screen 105 (e.g., right, left, top, or bottom of the touch screen 105). Although various implementations are described herein with reference to a tab marker, it should be understood that in some implementations any other indicator that would notify a user of the hidden system menu may be used in lieu of or in addition to the tab marker.

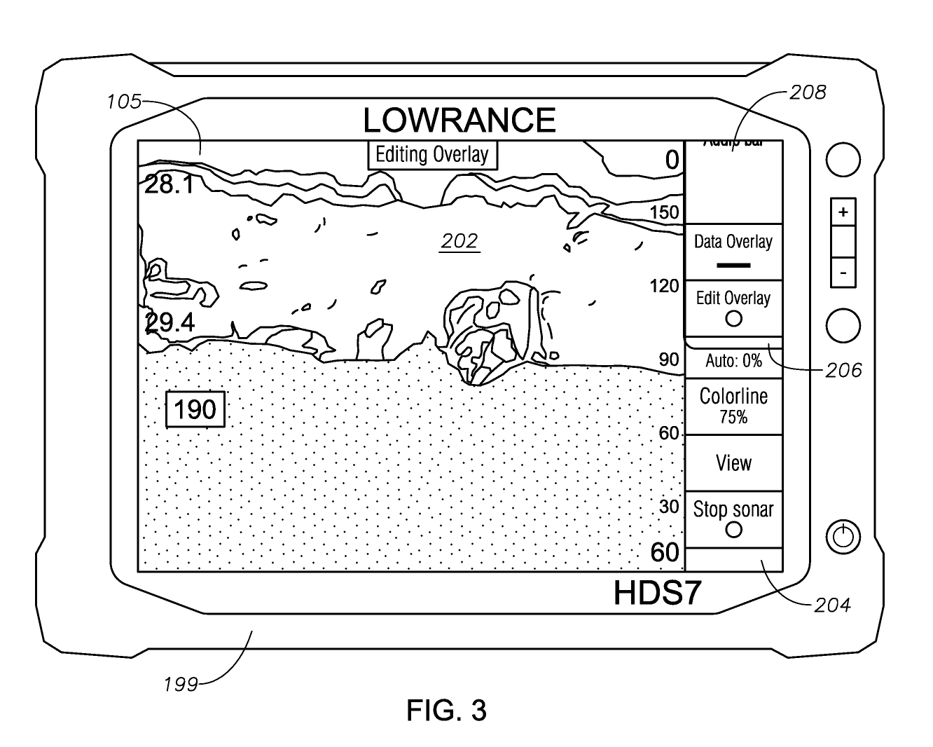

The portion of the hidden system menu that is generally hidden from the user's perspective may be displayed when the user sends a display request to the touch screen 105. In particular, the user may send the display request by touching an area of the touch screen 105 at or proximate to the tab marker 206. In one implementation, in order to send the display request, the user may perform a first gross swipe gesture at the tab marker 206, and the hidden system menu may be generally displayed by moving across the touch screen 105 in the same direction as the first gross swipe gesture. One or more types of gestures may be used for the first gross swipe gesture. For example, the user may perform the first gross swipe gesture by quickly flicking one or more fingers on the touch screen 105 in a downward direction at the tab marker 206, and the hidden system menu may move generally downward to the bottom of the touch screen 105. In another example, as illustrated in FIG. 3, if the user slowly drags one or more fingers downward on the touch screen 105 starting at the tab marker 206, the hidden system menu 208 may move generally downward across the touch screen 105 in real-time with the motion of the one or more fingers. FIG. 3 illustrates a schematic diagram of the partially displayed hidden system menu 208 in response to the user's gross swipe gesture at the tab marker 206 in accordance with various implementations described herein. As illustrated, as the user slowly drags a finger downward on the touch screen 105 starting at the tab marker 206, the hidden system menu 208 is nearly fully displayed as it moves down towards the bottom of the touch screen 105. Although the hidden system menu has been described as being fully displayed upon receipt of a gross swipe gesture in a downward direction, it should be understood that the user may perform the gross swipe gesture at the tab marker 206 in any direction as needed to generally display the hidden system menu, such as a downward, upward, leftward, or rightward direction.

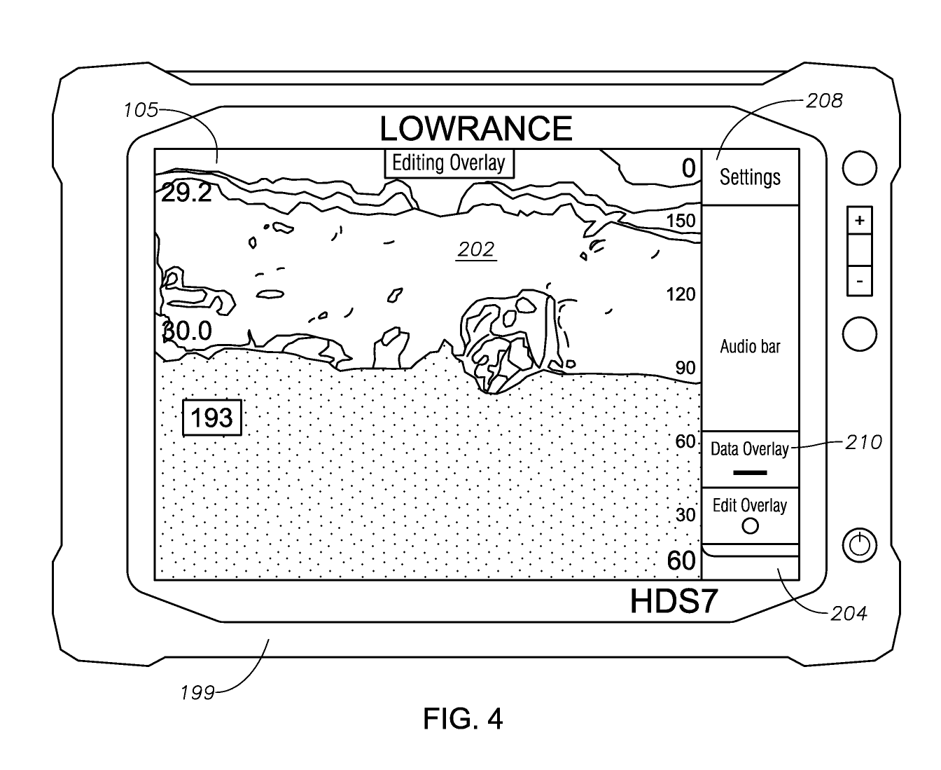

FIG. 4 illustrates a schematic diagram of the fully displayed hidden system menu 208 after it has completed its movement across the touch screen 105 in accordance with various implementations described herein. In one implementation, the hidden system menu 208 may generally obscure the side menu 204 after completing its movement across the touch screen 105, as illustrated in FIG. 4. In another implementation, the hidden system menu 208 may touch a bottom edge of the touch screen 105 when fully displayed.

The hidden system menu 208 may include one or more hidden system options 210 to enhance, alter, and/or edit the displayed sonar data 202. For example, the hidden system options 210 may include one or more options to add or remove data overlays on the displayed sonar data 202, add or remove an audio bar, display a status of the MFD or a vessel (e.g., alarm information, depth, speed, or notifications), perform system-wide functions, perform emergency actions (e.g., activate man-overboard), save a waypoint, control brightness of the touch screen 105, control power circuits of the vessel, switch radar to standby, or access further settings relating to the displayed sonar data 202. Each of the hidden system options 210 may be selected by the user via touching of the touch screen 105. In one implementation, the hidden system options 210 may be scrollable within the hidden system menu 208, such that a user can touch and drag the contents of the hidden system menu 208 in an up-and-down or left-to-right direction in order to scroll through all of the hidden system options 210.

In one implementation, the hidden system options may be global options, which may be applicable for any type of marine electronics data displayed on the screen. In another implementation, the hidden system options may be local, which may be unique to a particular type of marine electronics data displayed on the screen. For example, a displayed chart data may have a hidden system menu with an option to save a waypoint, while a hidden system menu of a displayed sonar data may not include such an option. In a further implementation, the hidden system menu may be a combination of global hidden system options and local hidden system options.

The user may also send a hide request to the touch screen 105 in the area at or proximate to the tab marker 206 in order to generally hide the hidden system menu 208 after it has been displayed. In one implementation, in order to send the hide request, the user may perform a second gross swipe gesture at the tab marker 206 in a direction opposite to the first swipe gesture. The hidden system menu 208 may then be generally hidden by moving across the touch screen 105 in the same direction as the second gross swipe gesture. In one implementation, the second gross swipe gesture may be performed along any portion of the hidden system menu 208.

Similar to the first swipe gesture, one or more types of gestures may be used for the second gross swipe gesture. For example, the user may perform the second gross swipe gesture by quickly flicking one or more fingers on the touch screen 105 in an upward direction, and in response the hidden system menu 208 may move generally upward to the top of the touch screen 105 until only the tab marker 206 is generally displayed. In another implementation, if the user instead slowly drags one or more fingers upward, the hidden system menu may move upward across the touch screen 105 in real-time with the motion of the one or more fingers. The user may perform the second gross swipe gesture along the hidden system menu in any direction as needed to generally hide the hidden system menu, such as a downward, upward, leftward, or rightward direction.

### Scroll Indicator

As marine electronics data is displayed on the touch screen 105, various menus may also be displayed on the touch screen 105 and used to enhance, alter, and/or edit the displayed marine electronics data. Such menus may include the side menu 204 or the hidden system menu 208. In addition, the menus may each include one or more options which may be used to perform the enhancement, alteration, and/or editing of the displayed marine electronics data. The user may be able to select any one of the options by touching the options on the touch screen 105.

In some implementations, every option of a displayed menu may not be fully displayed on the touch screen 105. For example, a menu may have a large number of options such that the touch screen 105 lacks sufficient screen area to display each option. Accordingly, such menus may include one or more generally hidden or partially-displayed options. However, such a menu may be scrollable, such that a user may send a command to the MFD 199 to scroll through the options of the menu by touching and dragging the contents of the menu in an up-and-down or left-to-right direction. In one implementation, the user may scroll through the menu by touching and dragging the contents on the menu using any portion of the menu. Upon scrolling through the menu, the generally hidden and/or partially-displayed options of the menu may become fully displayed and accessible to the user on the touch screen 105.

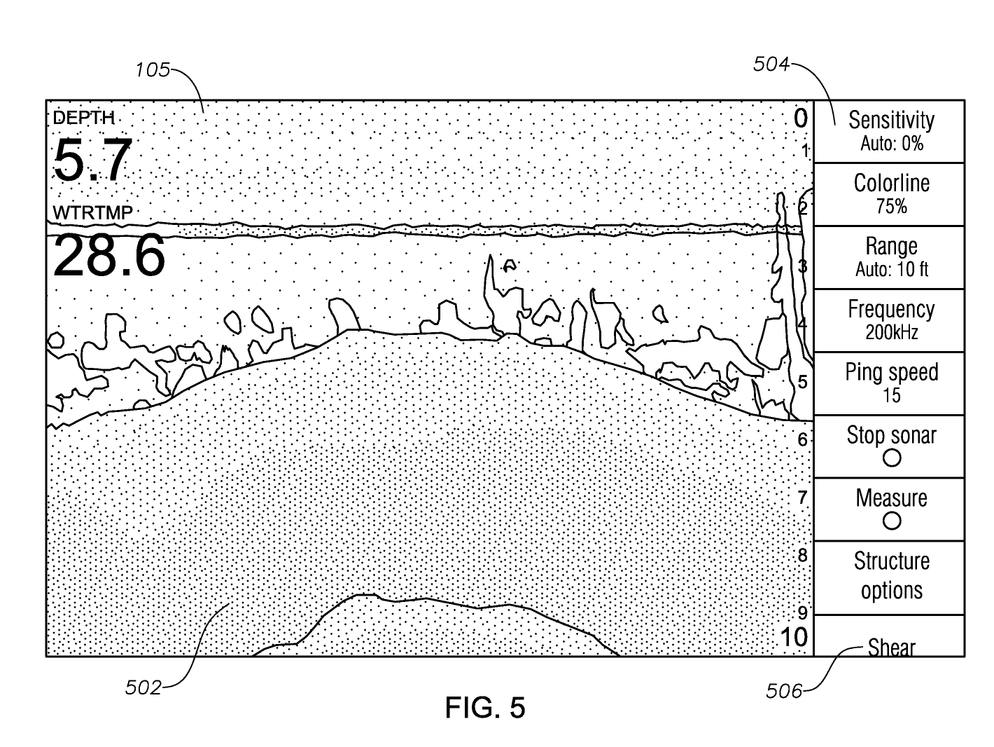

A scroll indicator on the menu may provide notice to the user of the existence of the menu's generally hidden options, where these options may become displayed and accessible upon scrolling through the menu. In one implementation, the scroll indicator may be a partially-displayed option of the menu itself, as illustrated in FIG. 5. FIG. 5 illustrates a schematic diagram of the touch screen 105 in accordance with implementations of various techniques described herein. The touch screen 105 may display sonar data 502. In addition, the touch screen 105 may also display a side menu 504, which may include one or more side options to enhance, alter, and/or edit the displayed sonar data 502. The user may select any of the side options by touching the touch screen 105. A partially-displayed option 506 may be at a bottom end of the side menu 504, such that only a top-half of the partially-displayed option 506 is displayed on the touch screen 105. In other implementations, the partially-displayed option 506 may be placed at any end of the side menu 504, such that any half of the partially-displayed option 506 may be displayed. The partially-displayed option 506 may provide notice to the user of the existence of the generally hidden options of the side menu 504. The user may then scroll through the side menu 504 in order to display the generally hidden options.

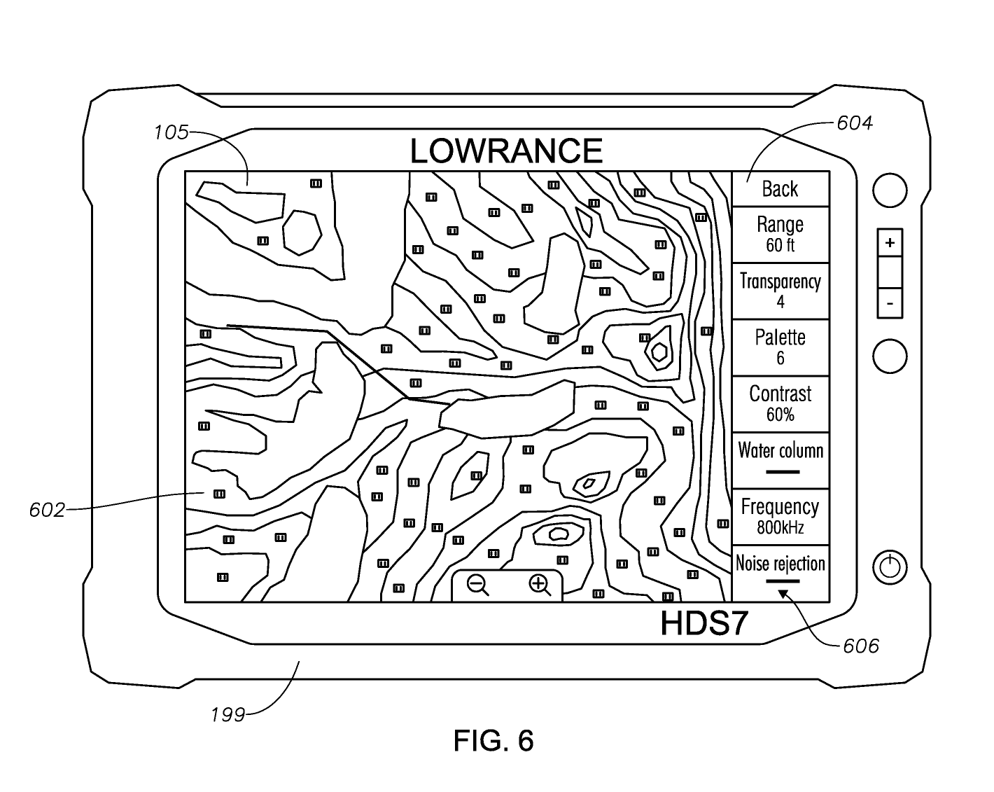

In another implementation, the scroll indicator of more options to be viewed in the menu may be, as illustrated in FIG. 6, an arrow indicator 606. FIG. 6 illustrates a schematic diagram of touch screen 105 of the MFD 199 in accordance with implementations of various techniques described herein. The touch screen 105 may display chart data 602. In addition, the touch screen 105 may also display a side menu 604, which may include one or more side options to enhance, alter, and/or edit the displayed chart data 602. The user may select any of the side options by touching the touch screen 105. The arrow indicator 606 indicates to the user that there are generally hidden options of the side menu 604 that are not being displayed on the touch screen 105. In particular, the arrow indicator 606 points in a downward direction, thereby indicating to the user that the generally hidden options are located relatively beneath the arrow indicator 606. The user may then display and access the generally hidden options by scrolling up through the side menu 604, i.e., by touching and dragging the side menu 604 in an upward direction.

In other implementations, the scroll indicator may be placed anywhere along the menu, and may be used to indicate that the user should scroll in any direction within the menu, including up, down, left, or right. The scroll indicator may be implemented using arrows, text, colors, symbols, or any other visual indicator known to those skilled in the art.

### Tray Menu

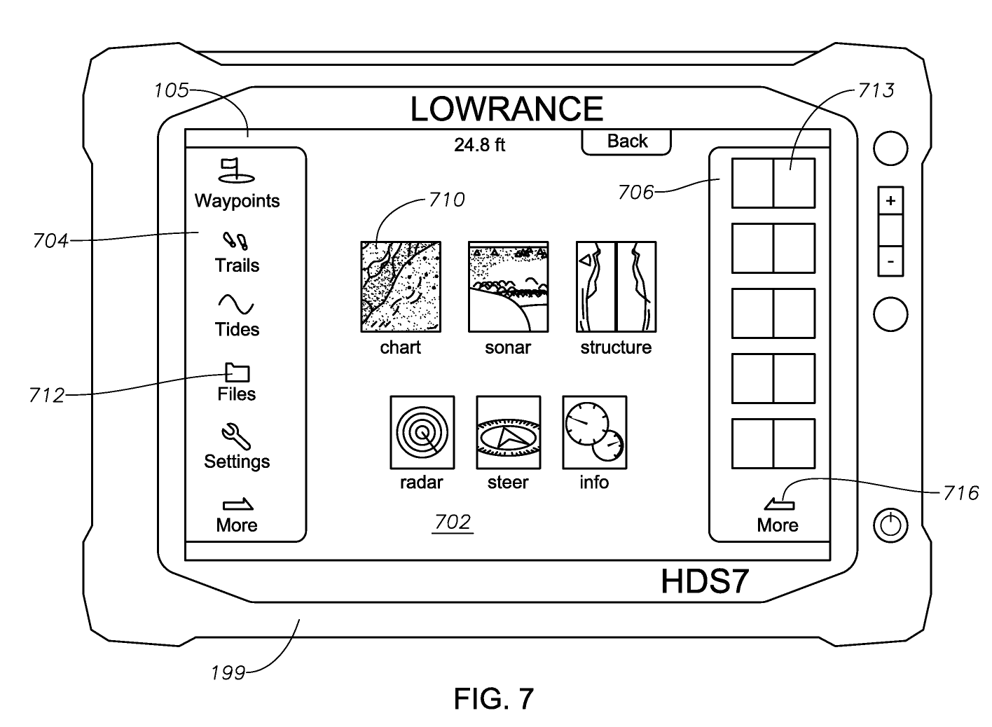

FIG. 7 illustrates a schematic diagram of touch screen 105 of the MFD 199 in accordance with implementations of various techniques described herein. The touch screen 105 may display a home screen 702. The home screen may include a number of home screen options 710 from which the user can select, including a choice of type of marine electronics data to display. In addition, the home screen 702 may also display one or more tray menus, such as the tray menus 704 and 706 illustrated in FIG. 7. The tray menus may be placed along any edge of the touch screen 105, such as the tray menu 704 being placed on a left edge and the tray menu 706 being placed on a right edge.

Each tray menu may include one or more displayed tray options which may be used to display, enhance, alter, and/or edit marine electronics data, such as the one or more displayed tray options 712 of tray menu 704 and the one or more displayed tray options 713 of tray menu 706. The displayed tray options may be displayed when the tray menus to which they belong are in use, and the user may select any of the displayed tray options by touching the touch screen 105. The displayed tray options may include options to display different types of marine electronics data simultaneously, options to alter settings of the touch screen 105, or any other option to display, enhance, alter, and/or edit marine electronics data as known to those skilled in the art. The displayed tray options may be preset by the MFD or may be added through customization by the user.

Each tray menu may also have one or more hidden tray options that, initially, may be generally hidden from the touch screen 105. For example, the hidden tray options may be generally hidden from the user's perspective. Similar to the displayed tray options, the hidden tray options may also be used to display, enhance, alter, and/or edit marine electronics data, and may be preset by the MFD or added through customization by the user. In order to generally display the hidden tray options for a tray menu on the touch screen 105, the user may send a tray display request to the touch screen 105 at or proximate to the tray menu.

In one implementation, in order to send the tray display request, the user may perform a first tray gross swipe gesture across the tray menu, and the tray menu may move across the touch screen 105 in the same direction as the first tray gross swipe gesture. The hidden tray options may then be generally displayed once the tray menu has moved across the touch screen 105. For example, the user may perform the first gross swipe gesture by quickly flicking one or more fingers on the touch screen 105 in a leftward direction across the tray menu, and the tray menu may then move generally leftward towards a center of the touch screen 105. In another example, starting at the tray menu, if the user slowly drags one or more fingers leftward towards the center of the touch screen 105, the tray menu may also move generally leftward towards the center of the touch screen 105 in real-time with the motion of the one or more fingers. In both examples, the hidden tray options may be generally displayed on the touch screen 105 once the tray menu has moved generally leftward across the touch screen 105. In other implementations, the user may perform the first gross swipe gesture across the tray menu in any direction as needed to generally display the hidden tray options, such as a downward, upward, leftward, or rightward direction.

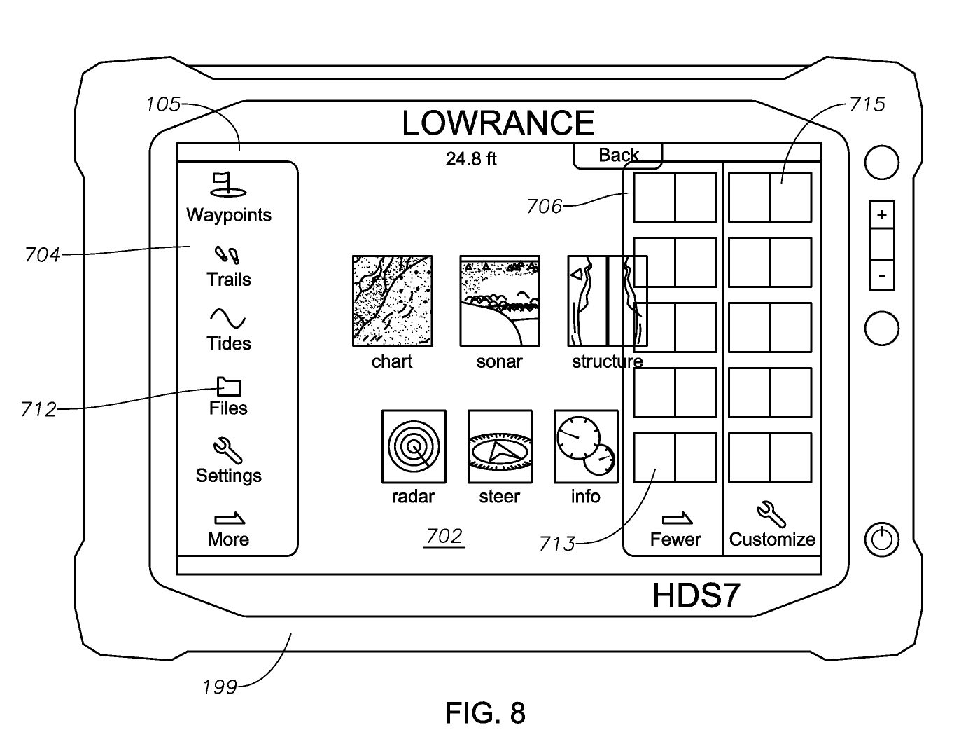

In another implementation, the user may send the tray display request by selecting one of the displayed tray options by touching the touch screen 105. For example, one of the displayed tray options 706 may be an arrow option 716, as illustrated in FIG. 7. Selection of the arrow option 716 may cause the tray menu 706 to move across the touch screen 105 in the same direction as pointed to by the arrow option 716. As illustrated in FIG. 7, the arrow option 716 points in a leftward direction, and, therefore, may lead to a generally leftward movement by the tray menu 706 if selected. The hidden tray options 715 may then be generally displayed once the tray menu 706 has moved across the touch screen 105, as illustrated in FIG. 8.

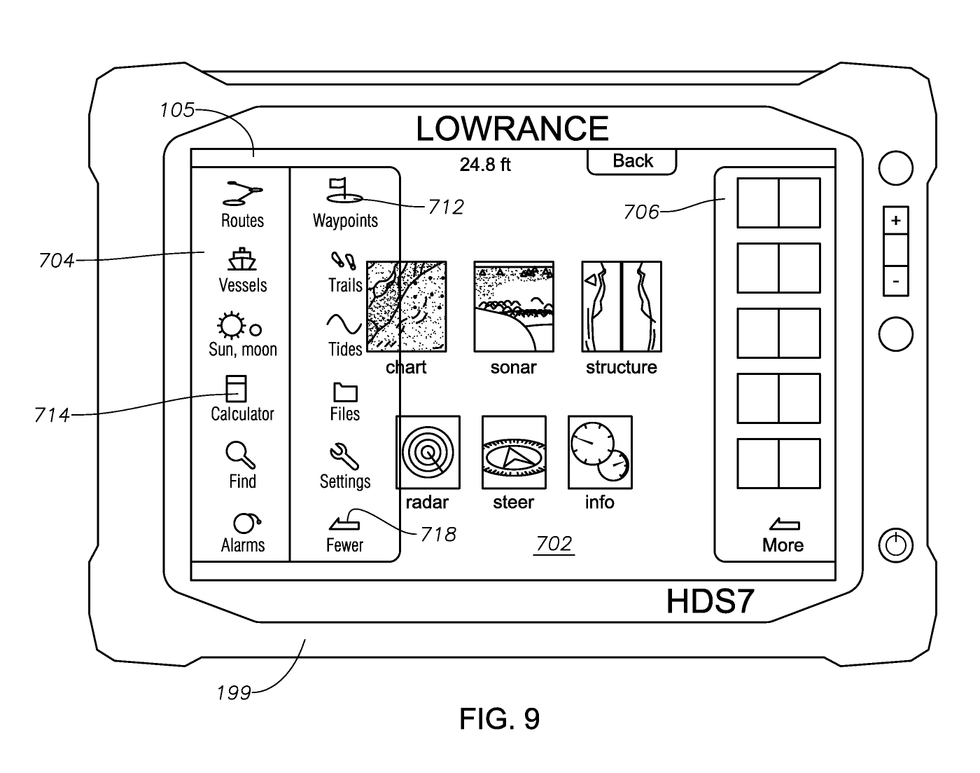

FIG. 8 illustrates a schematic diagram of the tray menu 706 in accordance with implementations of various techniques described herein, where, after receipt of a tray display request by the tray menu 706, its one or more hidden tray options 715 are displayed alongside the displayed tray options 713. FIG. 9 similarly illustrates a schematic diagram of the tray menu 704 in accordance with implementations of various techniques described herein, where, after receipt of a tray display request by the tray menu 704, its one or more hidden tray options 714 are displayed alongside the displayed tray options 712. As illustrated in both FIGS. 8 and 9, upon displaying the hidden tray options, the MFD 199 may dim areas of the touch screen 105 which do not include the tray menu.

The user may also send a tray hide request to the touch screen 105 at or proximate to a tray menu in order to generally hide its hidden tray options. In one implementation, in order to send the hide request, the user may perform a second tray gross swipe gesture across the tray menu in a direction opposite to the first tray swipe gesture. The hidden tray options may then be generally hidden by moving the tray menu across the touch screen 105 in the same direction as the second tray gross swipe gesture. For example, the user may perform the second gross swipe gesture by quickly flicking one or more fingers on the touch screen 105 in a rightward direction across the tray menu, and the tray menu may then move generally rightward towards a right edge of the touch screen 105. In another example, starting at the tray menu, if the user slowly drags one or more fingers towards the right edge of the touch screen 105, the tray menu may also move generally towards the right edge of the touch screen 105 in real-time with the motion of the one or more fingers. In both examples, the hidden tray options may be generally hidden on the touch screen 105 once the tray menu has moved generally rightward across the touch screen 105.

In another implementation, the user may send the tray hide request by selecting one of the displayed tray options via touching of the touch screen 105. For example, one of the displayed tray options 706 may be an arrow option 718, as illustrated in FIG. 9. Selection of the arrow option 718 may cause the tray menu 706 to move across the touch screen 105 in the same direction as pointed to by the arrow option 718. As illustrated in FIG. 9, the arrow option 718 points in a leftward direction, and, therefore, may lead to a generally leftward movement by the tray menu 706 if selected. The hidden tray options 714 may then be generally hidden once the tray menu 706 has moved leftward across the touch screen 105.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A non-transitory computer-readable medium having stored thereon a plurality of computer-executable instructions which, when executed by a computer, cause the computer to:
display marine electronics data on a touch screen on a multi function display unit;
receive a display request to display a marine electronics data menu that is generally hidden from the touch screen; and
display the marine electronics data menu on the touch screen in response to the display request by moving the marine electronics data menu across the touch screen in a first direction.

2. The non-transitory computer-readable medium of claim 1, wherein the marine electronics data menu is generally moved across the touch screen based on a swipe gesture on the touch screen by a user.

3. The non-transitory computer-readable medium of claim 2, wherein the marine electronics data menu is generally moved downward based on a downward swipe gesture on the touch screen by the user.

4. The non-transitory computer-readable medium of claim 1, wherein the marine electronics data menu is generally moved across the touch screen based on a swipe gesture by a user at a tab marker of the marine electronics data menu, wherein the tab marker represents a portion of the menu displayed on the touch screen.

5. The non-transitory computer-readable medium of claim 1, wherein the plurality of computer-executable instructions are further configured to, after displaying the menu, select one or more options on the menu in order to configure the marine electronics data.

6. The non-transitory computer-readable medium of claim 5, wherein the one or more options on the menu comprise a data overlay option.

7. The non-transitory computer-readable medium of claim 5, wherein the one or more options on the menu comprise at least one global option available to one or more types of marine electronics data.

8. The non-transitory computer-readable medium of claim 5, wherein the one or more options on the menu comprise at least one local option available to a particular type of marine electronics data.

9. The non-transitory computer-readable medium of claim 1, wherein the plurality of computer-executable instructions are further configured to:
receive a hide request to generally hide the menu from the touch screen; and
generally hide the menu in response to the hide request by moving the menu across the touch screen in a second direction opposite to the first direction.

10. The non-transitory computer-readable medium of claim 9, wherein the plurality of computer-executable instructions are further configured to generally hide the menu in response to the hide request by moving the menu upward based on an upward swipe gesture on the touch screen by a user.

11. The non-transitory computer-readable medium of claim 9, wherein the plurality of computer-executable instructions are further configured to generally hide the menu in response to the hide request by moving the menu upward based on an upward swipe gesture by a user at a tab marker of the menu, wherein the tab marker comprises an end portion of the menu.

12. A non-transitory computer-readable medium having stored thereon a plurality of computer-executable instructions which, when executed by a computer, cause the computer to:
display a scroll indicator on a menu of a touch screen on a multi function display unit, wherein the scroll indicator indicates additional menu options generally hidden from the touch screen;
receive a command to scroll the menu; and
display the additional menu options in response to receiving the command to scroll.

13. The non-transitory computer-readable medium of claim 12, wherein the scroll indicator comprises a partially-displayed menu option.

14. The non-transitory computer-readable medium of claim 12, wherein the scroll indicator comprises an arrow indicator.

15. A non-transitory computer-readable medium having stored thereon a plurality of computer-executable instructions which, when executed by a computer, cause the computer to:
display a marine electronics tray menu having one or more options displayed on a touch screen of a multi-function display and one or more options hidden from the touch screen;
receive a request to more fully display the one or more hidden options, wherein the request is received at the marine electronics tray menu; and
display the one or more hidden options more fully on the touch screen in response to the receiving the request.

16. The non-transitory computer-readable medium of claim 15, wherein the plurality of computer-executable instructions which, when executed by the computer, cause the computer to display the one or more hidden options more fully comprises a plurality of computer-executable instructions which, when executed by the computer, cause the computer to move the marine electronics tray menu across the touch screen.

17. The non-transitory computer-readable medium of claim 15, wherein the request comprises a swipe gesture by the user across the tray menu.

18. The non-transitory computer-readable medium of claim 15, wherein the request comprises a swipe gesture by the user across the tray menu toward a center of the touch screen.

19. The non-transitory computer-readable medium of claim 15, wherein the request comprises a selection of one of the one or more displayed options.

20. The non-transitory computer-readable medium of claim 15, wherein the plurality of computer-executable instructions are further configured to:
receive a request to hide the one or more hidden options from the touch screen; and
move the marine electronics tray menu across the touch screen to hide the one or more hidden options in response to receiving the request to hide.
